(19) United States
(12) Patent Application Publication
(10) Pub. No.: US 2016/0252894 A1
(43) Pub. Date: Sep. 1, 2016

(54) Method for Optimizing a Motion Profile, Control Device and Technical System

(71) Applicant: Siemens Aktiengesellschaft, Muenchen (DE)

(72) Inventors: Raimund KRAM, Erlangen (DE); Andreas SCHWARZ, Kalchreuth (DE)

(73) Assignee: SIEMENS AKTIENGESELLSCHAFT

(21) Appl. No.: 15/053,029

(22) Filed: Feb. 25, 2016

(30) Foreign Application Priority Data
Feb. 26, 2015 (EP) 15156695.7

(51) Int. Cl. G05B 19/402

(52) U.S. Cl. CPC G05B 19/402; G05B 2219/33116

(57) ABSTRACT

A method for providing an optimized motion profile, wherein a motion profile is divided into partial motion profiles to create the optimized motion profile, where the partial motion profiles are advantageously each linearly independent, i.e., the partial motion profiles are, for example, based on independent alignments and/or directions and/or they describe motions of at least one actuator for different spatial directions, and where the partial motion profiles are optimized independently of one another with the aid of at least one optimization method.

### BACKGROUND OF THE INVENTION

1. Field of the Invention

The invention relates to a method for optimizing a motion profile, a control device and technical system.

2. Description of the Related Art

Motion profiles are used to control a drive or a plurality of drives. A motion profile comprises, for example, motion specifications for a drive. Alternatively, a motion profile can also describe the curve on which an actuator, in particular an end effector, moves through space. A curve of this kind is also called a locus diagram. A movement specification can, for example, be a rotational speed as a function of the time.

To date, the calculation of motion profiles for a plurality of drives, in particular a plurality of drives in a technical system such as a robot, has been complicated. Frequently, an original motion profile is created manually and then optimized.

EP 2 022 608 B1 discloses a method for calculating a trajectory, wherein the trajectory is specified as a sequence of one or more path segments.

### SUMMARY OF THE INVENTION

It is an object of the present invention to simplify the creation of a motion profile.

This and other objects and advantages are achieved in accordance with the invention by providing a method for optimizing a motion profile for the motion of at least one actuator via at least two drives of a technical system, preferably a robot or a parallel kinematics machine, where an original motion profile is divided into several partial motion profiles. In accordance with the invention, an optimization method optimizes the partial motion profiles to form optimized partial motion profiles.

Optionally, an optimized total motion profile (hereinafter referred to as an optimized motion profile) can be created from the partial motion profiles by combining them. The optimized motion profile is provided for controlling drives of a technical system, in particular with the aid of a control device. Alternatively, the optimized partial motion profiles can be used to control the drives of the technical system and to this end transferred individually to the control device.

Advantageously, (optimized) partial motion profiles from a depiction as a locus diagram can be transformed and/or re-transformed into a speed profile (alternatively an acceleration profile or a jerk profile) for a drive or a plurality of speed profiles for a plurality of drives.

To achieve the object, a control device is also used to control at least two drives, where the drives are provided for the motion of at least one actuator in accordance with an optimized motion profile or in accordance with at least one optimized partial motion profile, wherein the provision of the optimized motion profile and/or of the at least one optimized partial motion profile is enabled by the above-identified method.

The object is also achieved by a computer program for carrying out the above-described method, where the computer program is executed on a computing unit and is intended to provide the optimized partial motion profiles and/or the optimized motion profile. In a preferred embodiment, the computer program is also suitable for the simulation of the control device so that it is advantageously possible to dispense with an additional control device.

It is further possible for the object to be achieved by a technical system, in particular a robot or a parallel kinematics machine, preferably for performing handling operations or pick- and place operations, comprising a control device for controlling at least two drives.

Here, a technical system should in particular be understood to be a machine tool, a production machine, a conveying device, a robot, a gripper (for example, as part of a robot), a picking and/or placing device, in particular a parallel kinematics machine, or a manipulating device.

Manipulating operations are also known as handling operations and a picking and/or placing device is also known as a “handling device” or manipulating device.

Here, a motion profile should be understood to be a specification defining how a component, in particular an actuator, moves through space. A motion profile, in particular an original motion profile, an optimized motion profile and an (optimized) partial motion profile can, for example, describe the locations traversed by a point of a component of the technical system at specific times. Thus, a motion profile is, for example, described by a time-dependent position vector. A motion profile can also be described by a speed profile, i.e., the course of the speed, the acceleration and of the jerk of a point or of an actuator as a function of the time.

Alternatively, a motion profile can be understood as being a course of the speed, the (rotational) torque and/or the (rotational) acceleration of a drive or a plurality of drives. In other words, a motion profile of this kind can also be a function of the (rotational) speed of a drive as a function of the time.

A drive should be understood to be a motor, in particular an electrically driven motor, a linear motor, a servo motor, a torque motor and a pneumatic/hydraulic drive, such as an extendable cylinder.

A handling operation should be understood to mean that an actuator picks up an object at a first point, optionally changes the alignment/orientation of the object and sets it down again at a second point. For a handling operation (or manipulation operation), preferably a parallel kinematics machine, a manipulation device or a robot or a gripper is used as a technical system.

Here, an actuator should be understood to be a tool, a device for picking up least one object, in particular, a gripper or an end effector. In particular the actuator can be an end effector in the case of a robot or a parallel kinematics machine. However, an actuator can also be a sensor to be moved or a deflecting device to be moved.

Here, an optimization method should in particular to be understood to be a specification which changes a motion profile, in particular an original motion profile, such that (i) after completion of the specification, it (optionally) satisfies pre-specifiable physical boundary conditions, (ii) that the course of the motion profile matches a target preset. In this case, target presets can, for example, be the quickest possible traversal of the motion profile and/or the lowest possible load on the drives.

The optimization method is used to alter partial motion profiles such that the optimized partial motion profiles can be traversed more quickly or the technical system advantageously requires less energy for a traversal.

Suitable optimization methods are variation methods, genetic algorithms and/or further methods known to the person skilled in the art, which are suitable for changing a function, in particular a motion profile, as a function of the time or a position or an alignment such that the function is optimized according to the above-named presets.

In accordance with an embodiment of the invention, the (original) motion profile is divided in a plurality of partial motion profiles. In this case, the motion profile is divided into either:

1. partial motion profiles describing a (rotational) speed or a (rotational) torque of a drive as a function of the position, an alignment of an actuator and/or the time or

2. partial motion profiles defining the motion of the actuator in a defined direction of motion, in particular in a first direction of motion (x-direction), a second direction of motion (y-direction), a third direction of motion (z-direction) and/or in at least one alignment (for example, in accordance with Euler angles in at least one dimension) of the actuator of the technical system.

The optimization method is used to optimize the partial motion profiles to form optimized partial motion profiles. The optimization of one of the partial motion profiles is preferably performed independently of the optimization of the other partial motion profiles.

The technical system is advantageously equipped with a control device. The control device can be implemented by a programmable logical control (PLC). The control device can also be a computing unit with an interface for connecting the computing unit to the corresponding components of the technical system, in particular to a technical data circuit.

A computing unit should be understood to be a personal computer (PC), a workstation, a node in a computer network, a notebook or a microcontroller or microprocessor.

The claimed computer program can also be embodied as a computer program product stored on a portable data carrier or for transfer via a computer network. The computer program or the computer program product is provided for installation on the computing unit, in particular on the control device of the technical system. The computer program installed on the computing unit or on the control device can be executed with the aid of a processor (CPU) of the computing unit or the control device. The computer program can also be loaded into a working memory of the computing unit or the control device for execution. The computer program advantageously has a machine-readable code, which can be interpreted and executed by a computing unit and used to provide an optimized (partial) motion profile.

In one advantageous embodiment, the method in accordance with the invention is performed with the aid of the control device and without a separate computing unit. This saves a separate computing unit.

The time can also be understood to mean the system time of the computing unit or the control device or a global time.

The method in accordance with disclosed embodiments of the invention can advantageously enable simplified optimization of a motion profile. The control device can advantageously enable a technical system to be upgraded so that no further separate computing unit is required. If the actual control unit is integrated in a computing unit, the computing unit is also able to take over further control functions of the technical system.

In another advantageous embodiment of the method, the optimization method takes into account physical boundary conditions. Physical boundary conditions should, for example, be understood to mean maximum speeds and/or maximum thermal loads of the drives. The physical boundary conditions can also include restrictions to the locus diagram, which take into account the fact that the actuator would strike an obstacle. The position of the obstacles can be changed. As a result, the physical boundary conditions can also be dependent on the time.

The optimization method advantageously takes into account the boundary conditions with the aid of Lagrange functions and/or Lagrange multipliers.

Taking into account physical boundary conditions during the optimization of the partial motion profiles advantageously results in the avoidance of (unnecessary) traversals of the optimization method if it transpires following the optimization of one partial motion profile that the optimized (partial) motion profiles do not meet the physical boundary conditions.

In a further advantageous embodiment of the method, the optimized partial motion profiles are combined to form an optimized (total) motion profile and a control apparatus in accordance with the optimized partial motion profiles and/or the optimized motion profile controls at least two drives.

The optimized partial motion profiles can either be used separately to control the drives and/or, following the at least one traversal of the optimization method, recombined to form an optimized motion profile.

Advantageously, a (combined) optimized motion profile can be transmitted to the control device. The control device then uses the optimized motion profile and/or the optimized partial motion profiles to control the drives of the technical system.

The presently contemplated embodiment has the advantage that it enables simple manipulation of a (combined) optimized motion profile. For example, it is possible to use a commercially available control device without any further changes in order to control a plurality of drives.

In this case, in one advantageous embodiment of the control unit, the method in accordance with disclosed embodiments of the invention is itself executed in the control unit. The method in accordance with disclosed embodiments of the invention only requires reduced computing capacity for the optimization of the motion profile. As a result, it can also be executed in a commercially available control device.

In a further advantageous embodiment of the method, the partial motion profiles and/or the optimized partial motion profiles describe motion variables of one drive in each case as a function of the time.

The motion variables can be a (rotational) speed of the drive or a provided (rotational) torque of a drive for describing the partial motion profile. Depending upon the motion variable or motion variables selected, the motion profile can be described and stored as a time-dependent function of the motion variable(s). A depiction of this kind is advantageous because the control device does not require any complex recalculation of the optimized (partial) motion profiles for controlling the drives.

In a further advantageous embodiment of the method, the partial motion profiles and/or the optimized partial motion profiles describe the motion variables of an actuator in a direction of motion as a function of the time.

A depiction of a locus diagram of the actuator is particularly clear to the user. A user's glance identifies a deviation of an intuitively reproducible locus diagram of the actuator. The above clarity is also obtained with (optimized) partial motion profiles.

Advantageously, it is also possible to specify an (optimized) (partial) motion profile as an alignment of a rotor of the drive as a function of the time. In the case of a linear drive, the (optimized) (partial) motion profile is a time-dependent function of the mobile element of the drive. Such depictions are also easy for the user to understand.

In addition, an optimization of a motion profile provided as a position function of an actuator can be optimized via the calculus of variations. In addition, it is also possible in a particularly simple way to combine the optimized partial motion profiles to form an optimized motion profile when using a position function.

In yet a further advantageous embodiment of the method, the partial motion profiles for different time ranges can be optimized with the aid of the optimization method. It is also possible for the duration of the time ranges themselves to be the object of the optimization.

In a further advantageous embodiment, the original motion profile, the partial motion profiles, the optimized partial motion profiles and/or the optimized motion profile are determined as position functions, speed functions, acceleration functions and/or jerk functions in each case of the time, the position of the actuator or an alignment of the actuator.

Frequently, some of the drives of the technical system are not operated continuously and/or motions of an actuator in one direction of motion are only moved in limited time ranges and not over the total operating time of the technical system.

Time ranges are in particular segments of time in which the speed, the acceleration and/or the jerk of the actuator and/or of the mobile part of the drive are different from zero.

Advantageously, the optimization can be restricted to the individual time ranges so that partial motion profiles do not have to be optimized for the total traversal time of the described motion of the actuator.

A method of this kind advantageously enables the traversal of the optimization method to be advantageously shortened.

An expansion of the optimization method to at least one time range can change its duration and temporal position. Thus, a partial motion profile, which defines the total duration of the traversal of the motion profile, such as a long-lasting motion of the actuator from one spatial point to another spatial point, can be optimized with respect to time optimization. A further partial motion profile, such as a change to the alignment of the actuator, can be optimized in this time with respect to minimum loss and/or energy optimization. At the same time, the temporal duration of the further partial motion profile can be increased in order to reduce the rotational acceleration.

Optionally, it is also possible for optimization to be performed over a short range beyond the limits of the time range. This procedure advantageously results in reduced actuator jerk.

In a further advantageous embodiment of the method, the time ranges partially overlap. Overlapping of the time ranges generally also enables the optimization of a plurality of partial motion profiles with the aid of an optimization method.

In another advantageous embodiment of the method, the first partial motion profile and the first optimized partial motion profile describe a motion of the actuator in a first direction, where the second partial motion profile and the second optimized partial motion profile describe a motion of the actuator in a second direction, and where the third partial motion profile and the third optimized partial motion profile describe a motion of the actuator in a third direction or an alignment of the actuator.

A technical system suitable for this has three axes or two axes and an alignment of the actuator.

A motion of an actuator can extend in both the horizontal direction (x-direction) and the vertical direction (y-direction). A motion profile which is executed as a locus diagram (individual motions) can be divided into at least a first and a second partial motion profile, where the first partial motion profile describes a motion of the actuator in the x-direction and the second partial motion profile describes a motion of the actuator in the y-direction.

Particularly advantageously, the (optimized) partial motion profiles describe orthogonal motions of the actuator or along directions of motion extending in the orthogonal direction.

Optionally, a third partial motion profile can describe the motion of the actuator in a third direction (z-axis). In addition, the third direction can also describe an alignment of the actuator, in particular of a gripper, about an angle.

The directions can also be described by two alignments and a motion in a radial direction or by three alignments of the actuator (with a constant radius of action of the actuator and/or another part of the technical system).

This assignment makes possible for the use to specify or describe an (original) motion profile in an intuitive and simple way. Moreover, the division of the (original/prespecified) motion profile advantageously does not require conversion or transformation into other coordinate systems.

In another advantageous embodiment of the method, the optimization method optimizes the partial motion profiles with respect to time optimization, energy optimization, jerk minimization and/or the minimization of vibrations in the technical system.

The partial motion profile is optimized with respect to time optimization if the traversal of the optimized (partial) motion profile takes the shortest possible time. In other words, this means that the optimized motion profile is executed such that the actuator or the drives are moved with the greatest possible speed or acceleration.

The partial motion profile is optimized with respect to energy optimization if the technical system, in particular the drives thereof, require as little energy as possible for one traversal of the (optimized) (partial) motion profile, i.e., the motion of the actuator from a prespecified starting point/alignment to another prespecified end point/alignment of the actuator. This can mean that the acceleration of drives or the actuator is minimized.

It is often necessary to have a middle way between time-optimized and energy-optimized optimization of the (partial) motion profile. Particularly advantageously, there is an optimization of one partial motion profile with respect to time optimization and an optimization of one further partial motion profile with respect to energy optimization and/or loss minimization.

The partial motion profile is optimized with respect to loss optimization if the losses of the technical system, in particular the drives of the technical system, are minimal. Losses can, for example, be heat losses, friction losses, losses due to eddy currents in an electrical machine, in particular of a drive, or (ohmic) resistance losses, in particular in windings of electrical machines.

The losses can be specified with reference to product specifications for the drives or further electronic/mechanical components/elements. These product specifications enable the optimization method used to be used for loss-minimized optimization of the (partial) motion profiles.

The partial motion profile is optimized with respect to jerk minimization if an increase in the acceleration of the drive and/or the actuator is as low as possible. Advantageously, jerk-optimized optimization has an advantageous impact on the lifetime of the technical system.

Optimization of a (partial) motion profile for the minimization of vibrations can be performed with the aid of a transformation of the (partial) motion profile and following a change to the transformed (partial) motion profile with subsequent inverse transformation. The transformation selected can, for example, be a Fourier transformation, in particular a fast Fourier transformation.

Avoiding vibrations during the motion of an actuator and/or at least one drive enables vibrations of the technical system to be avoided. Hence, the lifetime of the technical system is also advantageously increased and, if the technical system is a manipulation device, the goods to be manipulated are advantageously protected.

In another advantageous embodiment of the method, the physical boundary conditions are dependent on the time. The observance of physical boundary conditions that are dependent on the time can, for example, prevent an unforeseen collision of the actuator with a moving element of the technical system or a further moving element. As a further advantage, it is also possible to counteract overheating of a drive or a further electronic component by observing time-dependent physical boundary conditions.

In another advantageous embodiment of the method, the optimized motion profile and/or the optimized partial motion profiles are used to perform handling operations or a pick-and-place operation.

A preferred field of application of the method is the operation of a manipulation device, a robot or a parallel kinematics machine. The method is preferably used to determine how to protect an element to be manipulated. Particularly advantageously, the disclosed embodiments of the invention enables the simplified creation of an optimized motion profile or an optimized partial motion profile.

The invention is particularly suitable for the creation of a motion profile for handling or for pick-and-place operations. A (partial) motion profile can also be a (partial) motion control in particular of an actuator.

A motion profile is, for example, a motion of an actuator for the achievement of a manipulation operation. The motion profile can be made up of independent individual motions, in particular (linear) independent individual motions in linearly independent directions (of motion).

The partial motion profiles (or individual motions in linearly independent directions) can be defined via the route/distance to be traversed, via the desired speed of the actuator or the corresponding at least one drive, the acceleration or retardation (of the actuator and/or the drive's rotor), and the course of the jerk (of the actuator and/or of the drive's rotor).

Advantageously, the (rotational) acceleration, the retardation and the (rotational) speed can be determined taking into account the physical boundary conditions, in particular the maximum above-described motion variables, according to the criterion of the shortest total time (for the technical system to traverse the motion profile) (time-optimized optimization).

The jerk at the start of acceleration, end of acceleration, start of retardation, end of retardation of the actuator or of the drive's rotor can be defined in accordance with loss-minimized or energy-optimized criteria (energy-optimized optimization, or loss-minimized optimization).

In particular, the partial motion profiles that are independent of the temporal embodiment of the further partial motion profiles can be optimized with a partial motion profile(s) independent of the other partial motion profiles with the aid of another optimization method. For example, a partial motion profile can be optimized with respect to time optimization, while a further partial motion profile is optimized with respect to loss minimization and/or time optimization.

In other words, partial motion profiles that do not determine the time (in particular a cycle time) can be optimized with respect to loss minimization and/or energy optimization. A motion profile should also be understood to be a traversing profile.

The partial motion profiles can then be flexibly superposed in time. For example, the jerk, which in particular affects the actuator, can be reduced by increasing the time required for a partial motion profile. Hence, a jerk can be temporally displaced in a direction of motion if there is a jerk in the other direction of motion in the same time range.

Temporally flexible superposition can be based on selectable start criteria (when a time range starts). It is also possible to use the starting conditions for a time range of a motion described with the aid of a partial motion profile to define the temporal end of the corresponding partial motion profile.

To assemble the optimized partial motion profiles for an optimized motion profile, in particular for transfer to a control device (also known as path control), the individual motions, in particular the partial motion profiles, are combined to form a total motion of the actuator and/or the drives. This provides the optimized motion profile.

The above combination can be performed with a vector addition of the speeds of the partial motion profiles. The speed can also be represented by an amount of a speed vector (temporal derivation of a position vector).

This combination in particular achieves a fast calculation of the path through the connection of the individual path segments (i.e. in particular partial motion profiles and/or segments thereof) with respect to the geometry of the path of the actuator and the dynamics of the actuator by optimized partial motion profiles.

The invention is particularly suitable for use with orthogonal motions (vertical direction of motion, horizontal direction of motion) and/or motions that are independent of each other (translatory movement, rotational movement) which are provided as motion profiles and are to be optimized. In particular, the invention can be applied to kinematics with that motions which are independent and/or orthogonal to each other are performed.

In addition to the application of the disclosed embodiments of the invention to parallel kinematics, application to delta kinematics, in particular delta kinematics with a rotary axis or SCARA kinematics, is also conceivable. Generally, the method in accordance with the invention is also applicable to handling operations extending beyond pick-and-place (picking and placing objects with the aid of a device provided therefore). The disclosed embodiments in accordance with the invention are in particular suitable for the provision of cyclical motion profiles.

This invention is in particular advantageous due to:

1. the provision of a method for the achievement of a motion operation for the manipulation cycle via the division of the motion profile into individual partial motion profiles. Here, the partial motion profiles can be optimized in accordance with specific (and according to the partial motion profile) advantageous optimization criteria with respect to time optimization, energy optimization or loss optimization.

2. The optimized partial motion profiles can be directly superposed to form an optimized motion profile. Alternatively, the (optimized) partial motion profiles can be used for example to describe a motion of the actuator or a drive rotor in a vertical direction, in a horizontal direction or a rotational movement. The described motion of the actuator can be used to determine points of the path, in particular points of the locus diagram, where speeds (of the actuator and/or the drive) can be assigned to points of the path. These points of the path are then departed from with the aid of the control device with the assistance of the drives.

3. The method according to the invention advantageously replaces one very complex analytical and/or numerical determination of a motion profile with a plurality of much less complex determinations of partial motion profiles. The multi-CPU computing units available nowadays can in particular determine these in parallel and in a time-saving way.

4. In one concept of the invention, the partial motion profiles are either combined and/or can be transferred separately into the control device. The method for the provision of the optimized motion profile can take place via the geometry of the trajectory curve (position function, in particular with respect to time) of the actuator, or via the dynamics (speed, acceleration, jerk function with respect to time) of the actuator.

To summarize, the above statements relate to motion control for handling operations. To this end, the motion operations (here called a motion profile) are divided into individual motions of a machine part (for example an actuator). The motion operations (partial motion profiles) can (at least partially) overlap temporally. (Optimized) partial motion profiles can be started and ended at different time points. The time points (start, end of the motion) can be changed with the aid of the optimization method.

Following the division of the motion control, the partial motion profiles can be optimized to ensure that these optimization criteria are met with respect to time optimization, vibration optimization and energy optimization. Following the optimization of the individual motions, these are provided as optimized partial motion profiles.

The start and end of a first (optimized) partial motion profile can also take place within the time range in that a further (optimized) partial motion profile is executed. The course of the (optimized) partial motion profile, which begins with the start and is executed to the end, describes the time range in which the (rotational) speed of an actuator (or of a drive) is not equal to zero. In this case, the dynamics (i.e., for example motional sequences) of the (optimized) partial motion profiles can be independent of each another.

The individual motion can be defined via the route of the actuator to be traversed, the speed of the actuator, the acceleration, the retardation and/or the jerk.

One particularly advantageous application of the invention entails kinematics with orthogonally extending axes, for example, Cartesian portals, but also general kinematics, in particular kinematics with independently executed motions.

Advantageously, partial motion profiles which, at least partially in different time ranges, are unequal to zero can be optimized independently of one another.

In a further advantageous embodiment of the method for the provision of the optimized (partial motion profile), the motion of the at least one actuator is performed with a smoothing function.

A smoothing function in conjunction with an (optimized) (partial) motion profile should be understood to mean that the actuator travels slightly beyond the target and then swings back onto the specified path. For example, a higher speed can be advantageously achieved with a constant jerk of the direction of travel of the at least one actuator.

Naturally, it should be understood the invention is also suitable for providing optimized (partial) motion profiles suitable for describing the motion of a plurality of actuators, where the actuators are also able to move independently of each another. In the case of an independent motion, only the number of (optimized) partial motion profiles increases.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The following describes and explains the invention in more detail with reference to figures. The individual exemplary embodiments show features, which can be combined or used individually by a person skilled in art without departing from the essence of the invention, in which:

FIG. 1 is a flow chart of a method for providing an optimized motion profile in accordance with the invention;

FIG. 2 is a schematic block diagram of a technical system with three drives;

FIG. 3 is a further flow chart of the method in accordance with an embodiment of the invention;

FIG. 4 is a schematic block diagram of a further technical system;

FIG. 5 shows graphical plots of possibilities for a (partial) motion profile in accordance with the invention;

FIG. 6 show graphical plots of possibilities for conversion in accordance with the invention; and

FIG. 7 is an additional flowchart of the method in accordance with the invention.

### DETAILED DESCRIPTION OF THE EXEMPLARY EMBODIMENTS

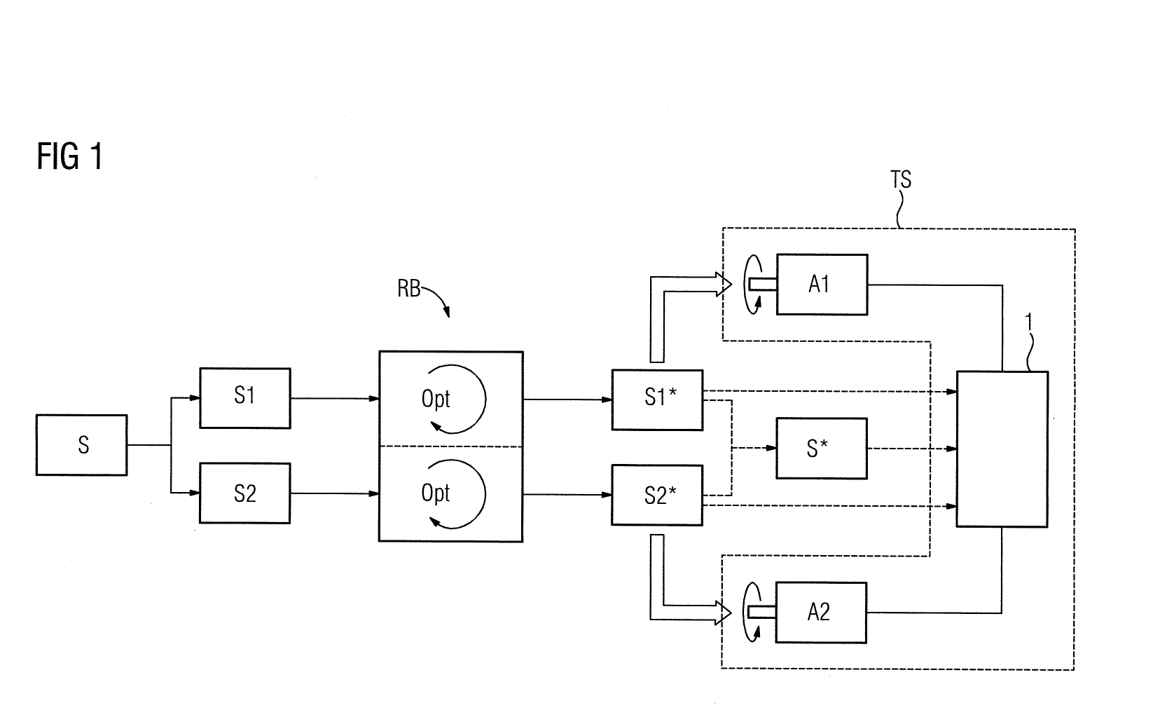

FIG. 1 shows a flow chart of a′ method for providing optimized motion profile S*. The method starts with an (original) motion profile S, which is divided into two partial motion profiles S1, S2. The two partial motion profiles S1, S2 are each optimized with the aid of an optimization method Opt to form two optimized partial motion profiles S1*, S2*. Here, an optimization method Opt is used to generate the optimized partial motion profile S1* from the first partial motion profile S1 and the second optimized partial motion profile S2 from the second partial motion profile S2*. Alternatively, different optimization methods Opt could be used for the optimization of different partial motion profiles S1, S2 as symbolized by the dashed line. In a further step, the optimized partial motion profiles S1*, S2* are combined to form an optimized motion profile S*. The optimized motion profile S* is transmitted to a control device 1. The control device 1 is used to control a first drive A1 and a second drive A2. The control device 1 and the two drives A1, A2 are part of the technical system TS. Alternatively, the control device 1 can also be provided separately from the technical system TS. The first optimized partial motion profile S1* can also be used directly without combination to form the optimized motion profile S* to control the first drive A1. This is symbolized by the wide arrow from the symbol of the first optimized partial motion profile S1* to the first drive A1. Similarly, the second drive A2 can be controlled directly by the second optimized partial motion profile S2* directly with the aid of the control device 1 as depicted symbolically by the second bent arrow from the symbol for the second optimized partial motion profile S2* to the second drive A2.

Advantageously, the optimization of the first partial motion profile S1 and the second partial motion profile S2 is performed with the aid of the optimization method Opt taking into account the physical boundary conditions RB. In this case, the physical boundary conditions RB can be the same for the two partial motion profiles S1, S2 or different physical boundary conditions can be provided for the different partial motion profiles S1, S2. The physical boundary conditions can also depend on the time t.

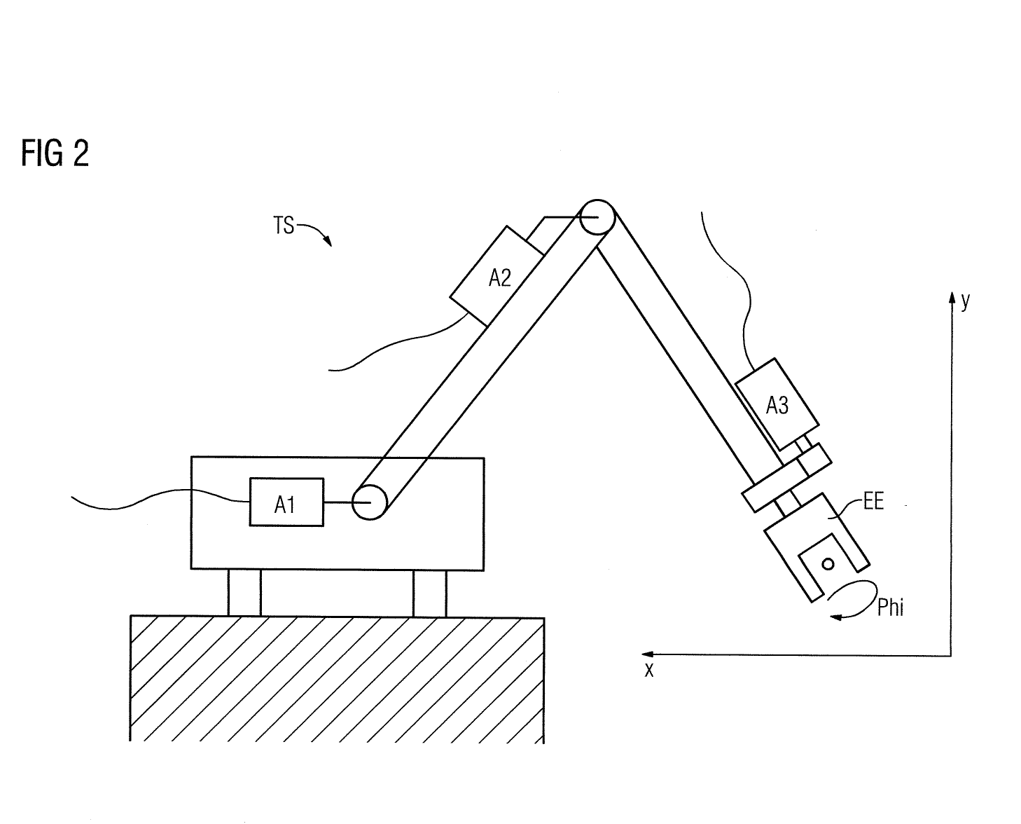

FIG. 2 describes a technical system TS with three drives A1, A2, A3. The technical system TS represents a robot TS, where the robot TS changes the alignment of a first arm with a first drive A1 on a base plate. A second drive A2 changes the alignment of a second arm, which is rotatably attached to the first arm. A third drive A3 changes the alignment Phi of the end effector or actuator EE. The motion of the center of gravity of the actuator EE can be described by the first and second directions of motion x, y. Movement of the center of gravity of the actuator EE in a first direction of motion x requires movement by the first drive A1 and simultaneously movement of the second drive A2. Similarly, movement of the center of gravity of the actuator EE in a second direction of motion y requires simultaneous movement of the first drive A1 and the second drive A2. The third drive A3, which is used for the alignment Phi of the actuator EE, is advantageously independent of the motion of the actuator EE in the first direction of motion x and/or in the second direction of motion y. If the robot performs manipulation operations, then the actuator EE is provided to pick and place the objects to be manipulated.

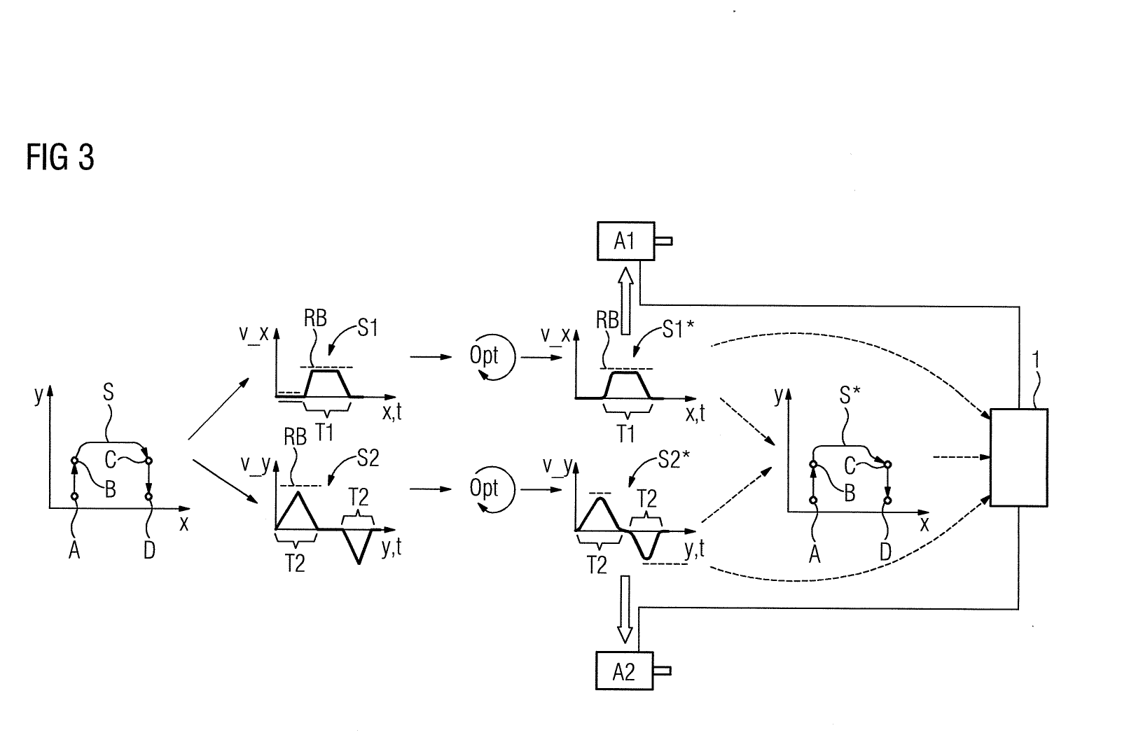

FIG. 3 shows a further flow chart of a method for providing an optimized motion profile S*. This shows the optimization of an (original) motion profile S, such as a manipulation device, as a technical system TS. Here, the motion profile S is described by a locus diagram of an actuator EE in two directions of motion x, y. In a first step, the original motion profile S is divided into a first partial motion profile S1 and a second partial motion profile S2. While the original motion profile S is shown as a position function of an actuator EE in two directions of motion x, y, the partial motion profiles S1, S2 are shown as speed profiles in the different directions of motion x, y. Here, S1 shows the course of the speed v_x in the first direction of motion x of the actuator EE as a function of a position x or as a function of the time t. S2 shows the course of the speed v_y of the actuator EE in the second direction of motion y as a function of the position y or the time t: In a first time range T1, the partial motion profile S1 has a speed different from zero in the first direction of motion v_x. The second partial motion profile S2 has a speed v_y different from zero in the second direction of motion y in two second time ranges T2. The two partial motion profiles S1, S2 are each transferred with the aid of the optimization method Opt to form optimized partial motion profiles S1*, S2*. Here, the optimization method Opt is used to create the first optimized partial motion profile S1* from the first partial motion profile S1. The second optimized partial motion profile S2* is calculated either by the same optimization method Opt or its own optimization method Opt.

The first motion profile S1 and the first optimized partial motion profile S1* are provided as a speed profile v_x in the first direction of motion x. The second partial motion profile S2 and the second optimized partial motion profile S2* are provided as a speed profile v_y in the second direction of motion y.

The first optimized partial motion profile S1* is assigned to a first drive A1 of the technical system TS. The second optimized partial motion profile S2* is assigned to the second drive A2 of the technical system. The assignment is symbolized by the arrows directed toward the drives A1, A2. It is also possible for the optimized partial motion profiles S1*, S2* to be combined to form an optimized motion profile S*. Following the combination of the two optimized partial motion profiles S1*, S2*, the optimized motion profile S* can be provided as a speed profile (v_x, v_y). Here, the optimized motion profile S* can again be provided as a position function of the actuator EE in the directions of motion x, y. The first optimized partial motion profile S1*, the second optimized partial motion profile S2* and also the optimized motion profile S* can be transferred to the control device 1. The control device 1 is used to control the first drive A1 and/or the second drive A2. The control device 1 can, but does not have to, form part of the technical system.

The dashed line in the depictions of the (optimized) partial motion profiles S1, S2, S1*, S2* symbolize the physical boundary conditions RB. The dashed arrows from the optimized (partial) motion profiles S1*, S2*, S* to the control device 1 symbolize the transmission of the optimized (partial) motion profiles into the control device 1. The arrows are shown dashed because the depicted method can also be implemented in the actual control device 1.

The time ranges T1, T2 are regions of the (optimized) partial motion profiles S1, S2, S1*, S2* in which the speeds v_x, v_y in the directions x, y of motion are unequal to zero. The time ranges T1, T2 can be displaced by the optimization with the aid of the optimization method Opt and/or changed with respect to their duration.

The (original) motion profile and the optimized motion profile can have points A, B, C, D defining the segments of the (optimized) motion profile S, S*. For example, at point A an object can be picked by the actuator EE. After being picked, the object is moved vertically in the second direction of motion y to the second point B. The object is moved from point B to point C in a curve-shaped motion. The curve is made up of motions of the actuator EE in the first direction x of motion and the second direction y of motion. From point C, the object is moved vertically in the second direction y of motion downward to point D and then set down with the aid of the actuator EE. Advantageously, the locus diagram (x (t), y (t)) can only be optimized from point B to C.

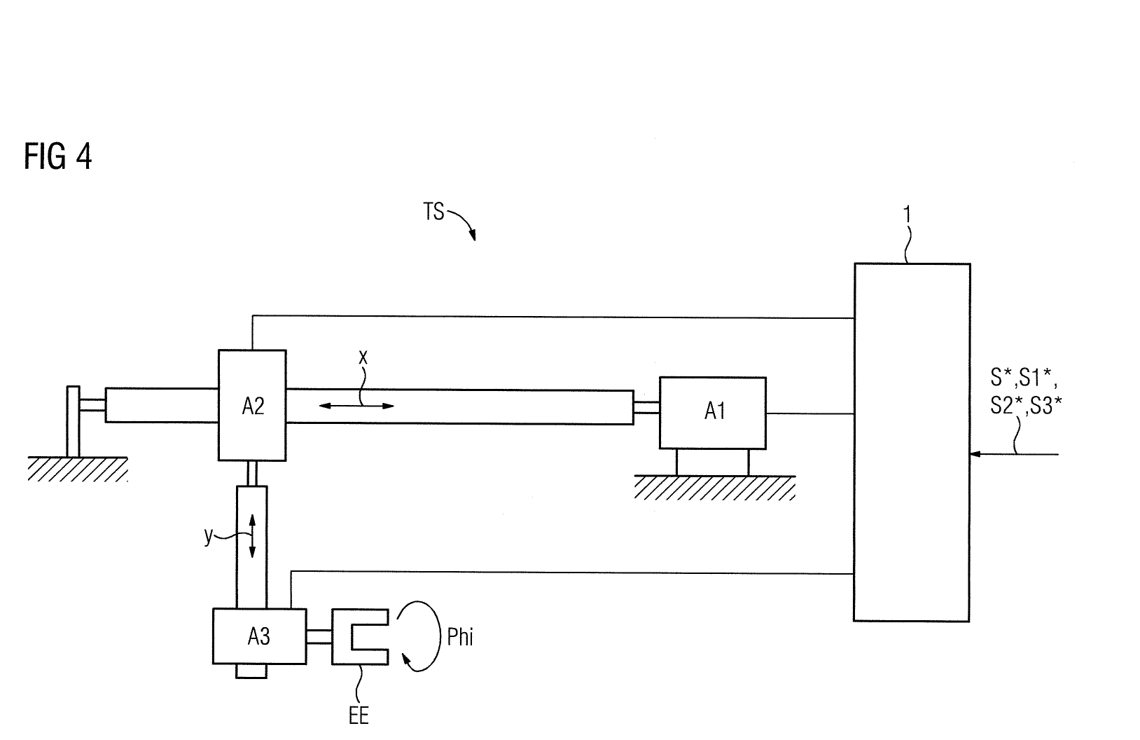

FIG. 4 shows a technical system TS. The technical system comprises a first drive A1, a second drive A2 and a third drive A3. The drives A1, A2, A3 are connected to the control device 1. The first drive A1 is used to move the actuator EE in a first direction of motion x. The second drive A2 is used to move the actuator EE in a second direction of motion y and the third drive A3 is used to change the alignment Phi of the actuator EE. The technical system TS is, for example, a robot, a manipulation device or a machine tool, where the actuator EE is the tool or a gripper device which is moved to the intended position with the drives A1, A2, A3.

The control device 1 receives the optimized partial motion profiles S1*, S2*, S3* and/or the optimized motion profile S*. The optimized motion profile and/or the optimized partial motion profiles S1*, S2*, S3* can be provided by a computing unit (not shown in the FIG) with the aid of a method for providing an optimized motion profile. The optimized (partial) motion profiles S1*, S2*, S3*, S* are transferred from the computing unit with the aid of a technical data circuit. With this embodiment of the drives A1, A2, A3 of the technical system TS, the motion of the first drive A1 acts directly on the position of the actuator EE in a first direction of motion x. Furthermore, a motion of the second drive A2 directly effects a motion of the actuator EE in the second direction of motion y and the motion of the third drive A3 directly effects a change to the alignment of the actuator EE into the desired alignment Phi. The two drives A1, A2 can advantageously be formed as linear motors. On the other hand, drive 3 is advantageously a conventional electric motor, i.e., a servo motor.

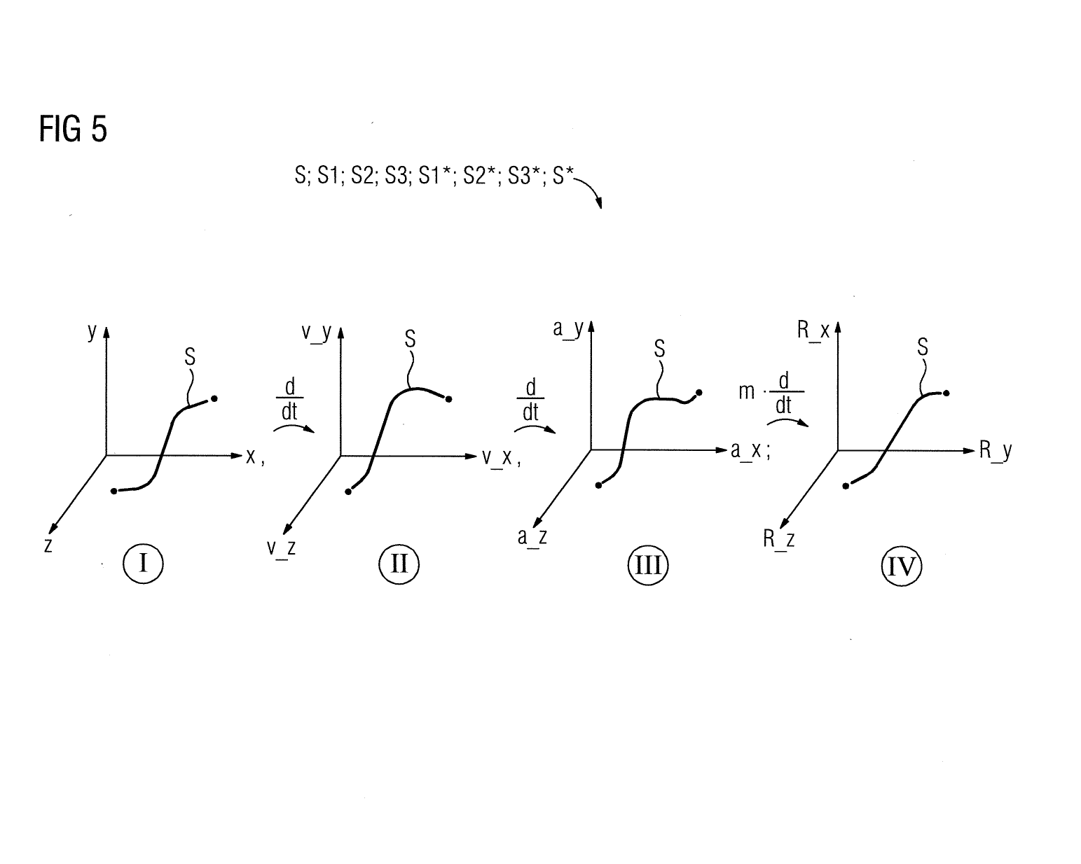

FIG. 5 shows graphical plots of possibilities for a motion profile S, an optimized motion profile S* and/or (optimized) partial motion profiles S1, S2, S3, S1*, S2*, S3*.

(I) shows a motion profile S depicted as a locus diagram, wherein the motion profile describes the motion of an actuator EE as a function of the three directions of motion x, y, z.

(II) shows a motion profile S as a derivation of a position function according to the time t (in each case symbolized by d/dt). This produces a motion profile S as a speed profile, where the motion of the actuator EE is described as a function of the speed v_x, v_y, v_z in a first direction of motion x, a second direction of motion y and a third direction of motion z.

(III) shows a further derivation according to time of the motion profile as shown in (II). Here, the (optimized) (partial) motion profile is shown as a function of the acceleration a_x in a first direction of motion x, the acceleration a_y in a second direction of motion y and as a function of an acceleration a_z in a third direction of motion z.

(IV) shows the (optimized) (partial)motion profiles as an example of the depiction of a jerk R_x, R_y, R_z in the first, second or third directions of motion x, y, z.

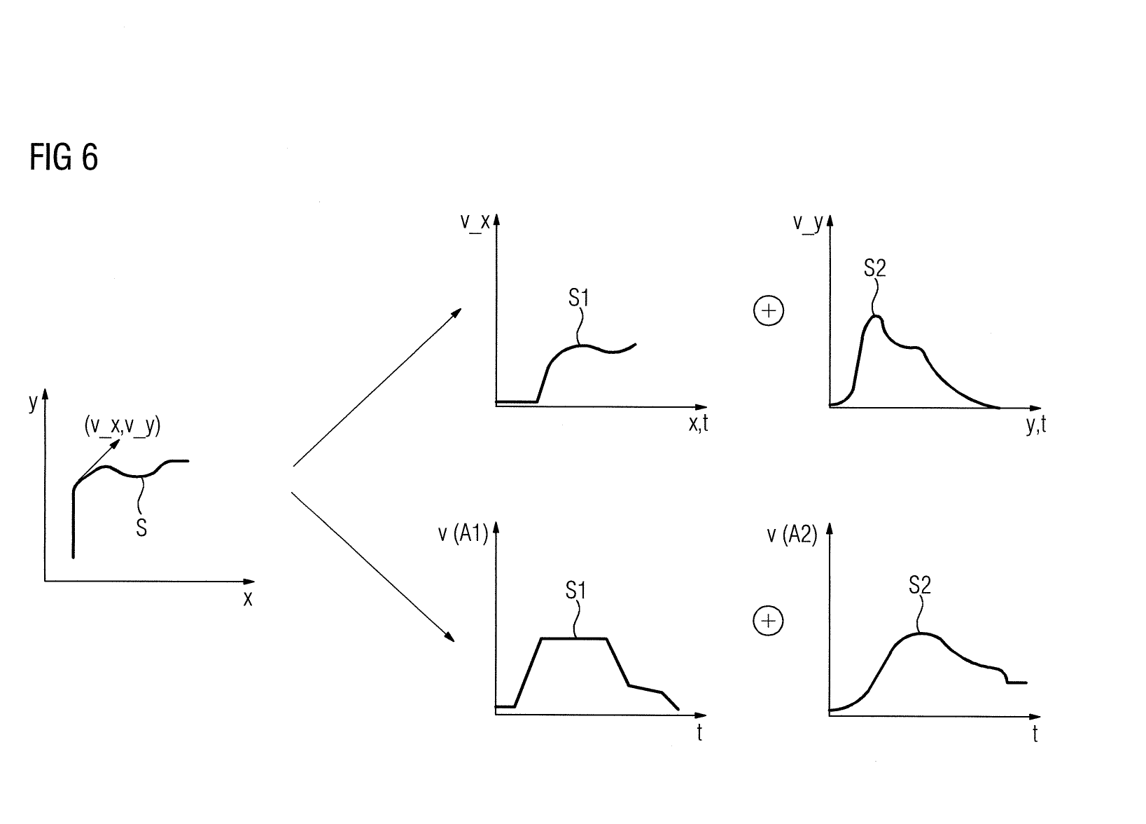

FIG. 6 shows graphical plots of possibilities for the conversion of a motion profile S (as a locus diagram), where the speeds v_x, v_y in the corresponding direction of motion x, y are provided as parameters for the locus diagram. As partial motion profiles S1, S2, this locus diagram can be shown in partial motion profile S1, S2 as speed curves v_x, v_y in the individual direction of motions x, y or as (rotational) speed curves v(A1), v(A2) of the individual drives A1, A2. The fact that in each case two adjacent partial motion profiles originate from the motion profile on the left-hand side is symbolized by the direct plus sign.

To summarize, the disclosed embodiments of the invention relate to a method for providing an optimized motion profile 5*. For the creation of the optimized motion profile S*, a motion profile is divided into partial motion profiles S1, S2, S3. The partial motion profiles S1, S2, S3 are each advantageously linearly independent, i.e., the partial motion profiles S1, S2, S3 are based, for example, on independent alignments (Phi) and/or directions x, y, z and/or they describe motions of at least one actuator EE for different (orthogonal) spatial directions x, y, z. The partial motion profiles S1, S2, S3 are optimized independently of one another with the aid of an optimization method Opt. Advantageously, physical boundary conditions RB can be observed during the optimization of the partial motion profiles S1, S2, S3. Following the optimization of the partial motion profiles S1, S2, the optimized partial motion profiles S1*, S2*, S3* can be combined again to form the optimized motion profile 5*. This enables the optimized motion profile S* and/or the optimized partial motion profiles S1*, S2*, S3* to be calculated particularly simply and quickly. Motion specifications for at least one drive A1, A2, A3 of the technical system TS are provided from the (optimized) partial motion profiles S1, S2, S3, S1*, S2*, S3* and/or the optimized motion profile S*.

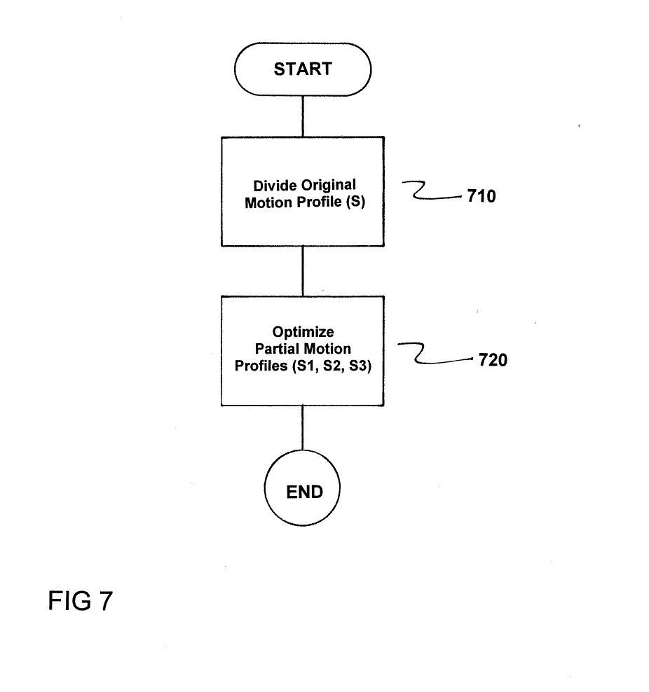

FIG. 7 is a flowchart of a method for optimizing a motion profile for motion of at least one actuator via at least two drives (A1, A2, A3) of a technical system (TS). The method comprises dividing an original motion profile (S) of the technical system (TS) into a plurality of partial motion profiles (S1, S2, S3), as indicated in step 710. Next, the plurality of partial motion profiles (S1, S2, S3) of the technical system (TS) as optimized via at least one optimization method (Opt) to form optimized partial motion profiles (S1*, S2*, S3*), as indicated in step 720.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for optimizing a motion profile for motion of at least one actuator via at least two drives of a technical system, the method comprising:
dividing an original motion profile of the technical system into a plurality of partial motion profiles; and
optimizing the plurality of partial motion profiles of the technical system via at least one optimization method to form optimized partial motion profiles.

2. The method as claimed in claim 1, wherein the optimization method takes into account physical boundary conditions.

3. The method as claimed in claim 1, wherein the optimized partial motion profiles are assembled to form an optimized motion profile; and
wherein a control apparatus in accordance with at least one of (i) the optimized partial motion profiles and (ii) the optimized motion profile controls at least two drives.

4. The method as claimed in claim 2, wherein the optimized partial motion profiles are assembled to form an optimized motion profile; and
wherein a control apparatus in accordance with at least one of (i) the optimized partial motion profiles and (ii) the optimized motion profile controls at least two drives.

5. The method as claimed in claim 1, wherein at least one of (i) the partial motion profiles and (ii) the optimized partial motion profiles each describe motion variables of a drive as a function of time.

6. The method as claimed in claim 1, wherein at least one of (i) the partial motion profiles and (ii) the optimized partial motion profiles describe motion variables of an actuator in a direction of motion as a function of time.

7. The method as claimed in claim 1, wherein the optimization method is utilized to optimize the plurality of partial motion profiles for different time ranges comprising actual time ranges.

8. The method as claimed in claim 1, wherein at least one of (i) the original motion profile, (ii) the plurality of partial motion profiles, (iii) the optimized partial motion profiles and (iv) an optimized motion profile are each determined as at least one of (i) position functions, (ii) speed functions, (iii) acceleration functions and (iv) jerk functions of time of a position of an actuator or an alignment of the actuator.

9. The method as claimed in claim 7, wherein the time ranges partially overlap.

10. The method as claimed in claim 8, wherein the time ranges partially overlap.

11. The method as claimed in claim 1, wherein a first partial motion profile and a first optimized partial motion profile describe a motion of an actuator in a first direction;
wherein a second partial motion profile and a second optimized partial motion profile describe the motion of the actuator in a second direction; and
wherein a third partial motion profile and a third partial motion profile describe the motion of the actuator in a third direction or an alignment of the actuator.

12. The method as claimed in claim 1, wherein the optimization method optimizes the plurality of partial motion profiles with respect to at least one of (i) time optimization, (ii) energy optimization, (ii) jerk minimization and (iii) to reduce vibrations in the technical system.

13. The method as claimed in claim 2, wherein the physical boundary conditions are time dependent.

14. The method as claimed in claim 1, wherein at least one of (i) the optimized motion profile and (ii) the optimized partial motion profiles are utilized to perform handling operations or pick-and-place operations.

15. The method as claimed in claim 1 wherein the technical system comprises one of (i) a robot, (ii) a parallel kinematics machine and (iii) a handling device.

16. A control device for controlling at least two drives, wherein the drives move at least one actuator in accordance with at least one of (i) an optimized motion profile and (ii) at least one optimized partial motion profile;
wherein at least one of the optimized motion profile and the at least one optimized partial motion profile is obtained by:
dividing an original motion profile of a technical system into a plurality of partial motion profiles; and
optimizing the plurality of partial motion profiles of the technical system via at least one optimization method to form the optimized partial motion profiles.

17. A technical system for performing manipulating operations or prick-and-place operations, comprising:
a control device for controlling at least two drives;
wherein the at least two drives move at least one actuator in accordance with at least one of (i) an optimized motion profile and (ii) at least one optimized partial motion profile;
wherein at least one of the optimized motion profile and the at least one optimized partial motion profile is obtained by:
dividing an original motion profile of a technical system into a plurality of partial motion profiles; and
optimizing the plurality of partial motion profiles of the technical system via at least one optimization method to form the optimized partial motion profiles.

18. The technical system of claim 17, wherein the technical system comprises one of (i) a robot, (ii) a parallel kinematics machine and (iii) a manipulating device.
